(19) United States
(12) Patent Application Publication
(10) Pub. No.: US 2005/0094267 A1
(43) Pub. Date: May 5, 2005

(54) Birefringent anaglyph

(76) Inventor: Mark J. Huber, Burbank, CA (US)

Correspondence Address: GREENBERG TRAURIG LLP, 2450 COLORADO AVENUE, SUITE 400E, SANTA MONICA, CA, 90404, US

(21) Appl. No.: 10/968,219

(22) Filed: Oct. 18, 2004

Related U.S. Application Data
(60) Provisional application No. 60/512,151, filed on Oct. 17, 2003.

(51) Int. Cl. G02F 1/1347; G02B 27/22

(52) U.S. Cl. 359/464

(57) ABSTRACT

Both linearly and circularly polarized glasses are used to resolve two-color anaglyph images. Linearly polarized glasses also are used to resolve circularly polarized images and vice versa. Modified two-color anaglyph glasses may be used to resolve standard linearly and circularly polarized images.

### RELATED APPLICATION

This application is a non-provisional application claiming benefit under 35 U.S.C. sec. 119(e) of U.S. Provisional Application Ser. No. 60/512,151, filed Oct. 17, 2003 (titled BIREFRINGENT ANAGLYPH by Mark J. Huber), which is incorporated in full by reference herein.

### BACKGROUND

The present disclosure relates to a system and method for viewing three-dimensional images.

An anaglyph is a moving or still picture consisting of two slightly different perspectives of the same subject in contrasting colors that are superimposed on each other, producing a three-dimensional (3D) effect when viewed through two correspondingly colored filters.

There are currently three incompatible techniques for presenting 3D imagery. In order for a person to view linearly polarized images, they must wear linearly polarized glasses. Similarly, to view circularly polarized images, a person must use circularly polarized glasses, and two-color anaglyph images must be viewed with two-color anaglyph glasses.

Generally, linearly polarized glasses cannot resolve anything but linearly polarized images, circularly polarized glasses only work with circularly polarized images, and two-color anaglyph glasses only work with anaglyph images.

### BRIEF DESCRIPTION OF THE DRAWINGS

For a more complete understanding of the present disclosure, reference is now made to the following figures, wherein like reference numbers refer to similar items throughout the figures.

FIG. 1 is an illustration of a standard anaglyph (e.g., red/blue) 3D system.

FIG. 2 is an illustration of a standard polarized 3D system.

FIG. 3 shows a Michel-Levy chart that plots birefringent color as a function of retardation. Zero retardation is to the left of the chart, with increasing retardation to the right. Retardation is presented in units of nanometers. First, second and third order retardation color ranges are shown.

FIG. 4 is a graph showing birefringent color caused by 1200 nm worth of retarders with crossed versus parallel polarizers.

FIG. 5 illustrates one embodiment whereby linearly polarized glasses are used to view a linearly polarized anaglyph image.

FIG. 6 illustrates one embodiment whereby linearly polarized glasses are used to view a circularly polarized anaglyph image.

FIG. 7 illustrates one embodiment whereby circularly polarized glasses are used to view a linearly polarized anaglyph image.

The exemplification set out herein illustrates selected embodiments in one form, and such exemplification is not intended to be construed as limiting in any manner.

### DETAILED DESCRIPTION

The present disclosure provides for techniques that allow both linearly and circularly polarized glasses to resolve two-color anaglyph images. The disclosure also allows linearly polarized glasses to resolve circularly polarized images and vice versa. The disclosure should also allow for modified two-color anaglyph glasses to resolve standard linearly and circularly polarized images.

The practice of the disclosure may provide the following advantages:
1. Allow linearly polarized glasses to resolve two-color anaglyph 3D images.
2. Allow circularly polarized glasses to resolve two-color anaglyph 3D images.

3. Allow the use of at least two currently incompatible media, in the same venue, using the same pair of guest observer eyeglasses.

In a basic system, two steps are generally performed. In the first step an anaglyph image is turned into a polarized anaglyph image. In the second step, birefringent color is generated that matches the color of the inks or other coloring means used to form the anaglyph image. The generated birefringent color may then “color” the lens so that the polarized lenses are able to work like red/blue anaglyph lenses. The glasses can then resolve a standard red/blue anaglyph image into a 3D image.

One of the most popular rides currently in existence is Universal Studio's “Spiderman” ride in Florida. In this ride guests wear passive linearly polarized glasses and view very large format linearly polarized 3D movies. In this kind of ride, the guest travels through a two-dimensional (2D) space composed of cartoon-colored flat billboards and cityscape images that link the 3D movie locations. The ride vehicle actually spends a considerable time moving through these empty 2D spaces.

The practice of the disclosure would therefore allow a designer to fill the drab 2D space between movie locations with cartoon-colored 3D anaglyph images. This would make every moment of the ride a 3D moment rather than a change from 2D to 3D spaces as one moves through the ride.

Another embodiment could allow the viewing of anaglyph 3D movies using either circularly or linearly polarized glasses. This would allow the showing of different 3D format movies at the same venue without changing the glasses worn by the guest observers.

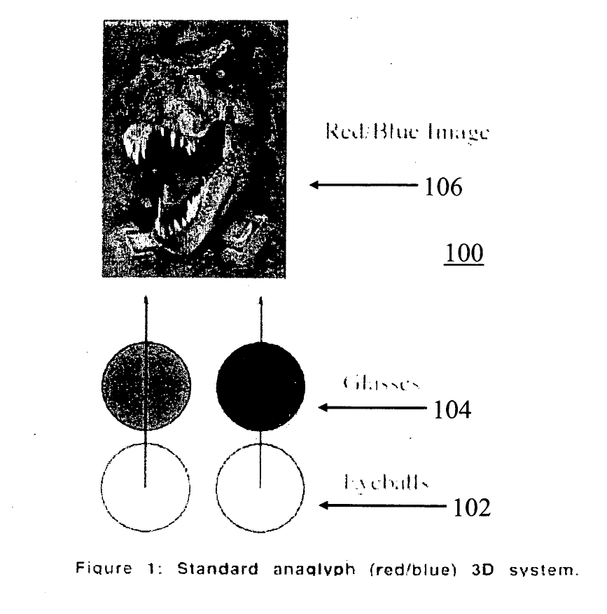

In FIG. 1, in a system 100, the guest (indicated by eyeballs 102) wears a pair of glasses 104 where one lens is typically red and the other lens is, for example, blue. In other systems, the other lens may alternatively be green or cyan. The viewed image 106 is composed of two slightly offset images—one is, in the example here, red and the other is blue. With other color combination types of anaglyph images, the offset images may be formed of other color combinations. As perceived by the guest, the image is combined into a 3D image.

System 100 works because the red lens causes the red image to appear brighter while the blue lens causes the red image to appear darker. The obverse is also true in which the blue lens causes the blue image to appear brighter while the red lens causes the blue image to appear darker. This ensures that the images are sufficiently isolated from each other and that “cross talk” is sufficiently minimized. This property is referred to as “image separation”. Typically, the pattern is (e.g., with red/blue glasses) that the color red is used in the left lens, the left image of the red/blue image is red, and the right image of the red/blue image is blue.

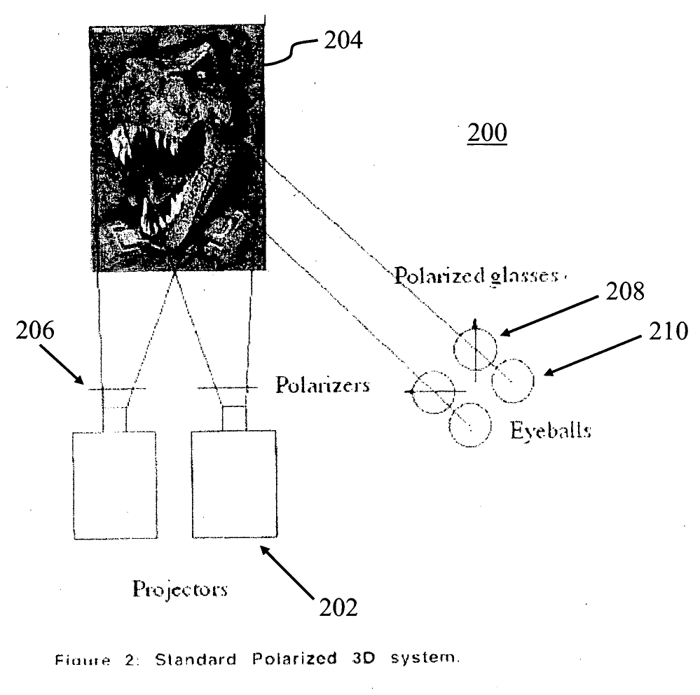

In FIG. 2, in a standard linearly polarized 3D system 200, two projectors 202 project slightly different images onto the same screen 204. Each of the projectors 202 has a linear polarizer 206 over its optics that polarizes the image for that projector. The polarization directions for the projector polarizers are typically at about 90 degrees to each other and typically at about 45 degrees to the horizon. The guest wears glasses 208 that have two polarizers that are also 90 degrees to each other and 45 degrees to the horizon, which matches the same pattern as the projector. In system 200, each eye of eyeballs 210 only receives the image from the projector 202 that has a similar polarization angle as the polarization angle of the lens over the eye. The other image is blocked. The two images are fused into a 3D image in the mind of the guest. System 200 can also be made to work using right and left circular polarizers at the projectors and left and right circular polarizers over the eyes.

Now discussing polarized birefringent color in more detail, an optical polarizer is a material that only allows light rays exhibiting specific vibration directions to pass through the material. Natural, non-polarized, light is composed of a number of light rays each exhibiting a random vibration direction. Optical polarizers allow specific vibration directions to pass through the media while blocking other vibration directions.

In a two-polarizer system, light rays from the first polarizer are either blocked or passed through the second polarizer. In the situation where the second polarizer has the same preferred orientation as the first polarizer, the light is passed through both polarizers. In the situation where the second polarizer has an orientation at 90 degrees to the orientation of the first polarizer, the light is blocked from moving through both polarizers.

In a birefringent color approach, however, an optically active material is inserted between the two polarizers. The following is a basic discussion regarding what happens to a representative light ray.

Natural, broad-band, non-polarized light rays from a light source impinge on a polarizer. These light rays, in passing through the first polarizer, become plane polarized in the privileged direction of the first polarizer.

This plane polarized light then impinges on a birefringent material, for example, directly at its surface. Birefringent materials are transparent substances that have structures that are chemically and/or physically asymmetric. This asymmetry manifests itself as multiple indices of refraction in the substance.

As the plane polarized light passes into the birefringent material, it resolves into two mutually perpendicular, non-interfering light rays. These two mutually perpendicular, non-interfering light rays take different paths through the birefringent material. One of the light rays (called the 0-ray) takes a path through the material where the direction of propagation of the light ray is perpendicular to the wave front normal of the wave. The other light ray (called the e-ray) moves along a direction which is not perpendicular to the wave front normal. Due to this phenomena, the two plane polarized light rays can take paths that are different lengths.

The fact that the two plane polarized light rays experience different indices of refraction and different travel paths leads to a process called retardation. In retardation, the phase relationship between the two incident light rays is changed. Since the velocity of light in a medium is a function of the index of refraction of the medium, it follows that the velocities of the two non-interfering light rays will be different in the substance if they experience different indices of refraction. Since the light rays take different paths through the material it follows that the path lengths can be different. Given both a velocity and a path length difference, it follows that the phase of one of the light rays can be changed in respect to the other light ray. In short, if two light rays start out in phase at the first surface of the birefringent material, the phase of one of the light rays can be changed in respect to the phase of the other light ray, by the time both light rays travel through the material.

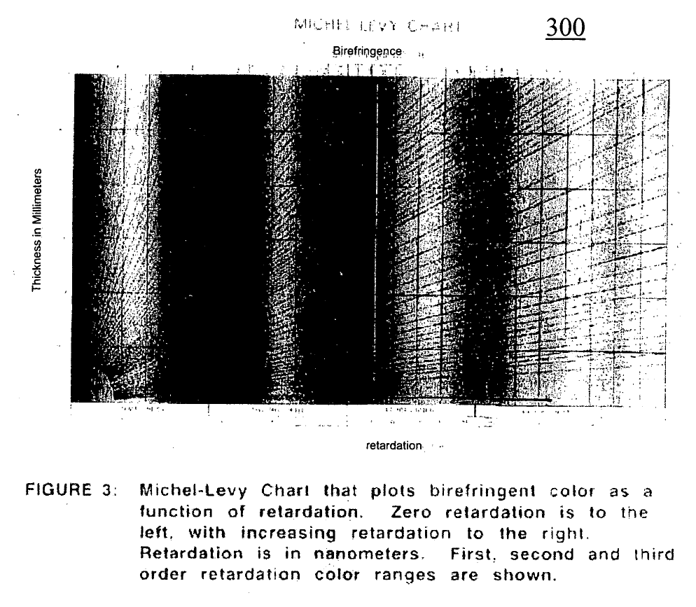

At the second surface of the birefringent material the two light rays interfere with one another and resolve back into a single polarized light ray. If a phase difference in the light rays has occurred, that phase difference manifests itself as a color. As discussed in more detail below (see FIG. 3), a Michel-Levy chart is a system that plots birefringent color as a function of retardation or phase difference.

Most naturally-occurring birefringent materials have either two or three indices of refraction. A slice taken out of one of these materials will have two indices of refraction. Naturally-occurring birefringent materials are typically crystalline and are very small in cross-section. This makes them unsuitable in this application. Some materials, such as, for example, polycarbonate manufactured by Autoglass, also exhibit birefringence. Many of these manufactured materials suffer from a lack of quality control and are of non-uniform thickness and non-uniform birefringence across the useful area. Scientific retarders are manufactured such that they are relatively large, of substantially uniform thickness, and have a substantially uniform birefringence across a useful area of the retarder.

In the case of this disclosure, there are two frequencies or colors of import. The first are the colors manifested with one or more retarders and a second polarizer, for example, 90 degrees to the plane of polarization of the first polarizer. The second are colors manifested with one or more retarders and a second polarizer, for example, parallel to the plane of polarization of the first polarizer. It turns out that a birefringent color manifested by the system at 90 degrees to the vibration direction of the first polarizer is an approximate complement to the color manifested by the system with a second polarizer parallel to the first polarizer. In this context, approximate complementary colors can be taken to mean that the colors are sufficiently independent from each other to provide the separation needed for a two-color anaglyph 3D process (i.e., sufficient separation so that an observer is able to perceive a 3D image). In short,. the images can be “separated” from each other. It should also be noted that the use of the phrase “approximately complementary” in this application includes, but is not limited to, the case of exact color complements. However, such exact complements are not expected to be achieved in actual practice.

In FIG. 3, a standard Michel-Levy chart 300 can be used to determine the color passed through two polarizers in the crossed or extinct positions. In the case of the present disclosure, the best match in one specific example described herein for the crossed polarizer color is the sum of (530 nm+530 nm+140 nm), or a total of 1200 nm. In chart 300, a 1200 nm retardation maps to a blue/green interference color. Color ranges as low as 530 nm have been explored and the present technique is still effective. It is believed that even lower color ranges may still be effective in other embodiments. Care is preferably taken in matching the colors of the inks or other coloring means or approach used to make the image to be observed by the guest. The coloring means that may be used in general means the source or types of light that will provide or create an image for viewing by an observer (e.g., the light coming from a television screen or reflected from a projection screen). Currently-available retarder products are typically limited to certain predefined amounts of retardation. However, it should be noted that given a sufficiently wide range of retarder choices, in general any desired set of colors could be selected for use. A standard Michel-Levy chart could be used to determine appropriate combinations of retarders when using other color combinations.

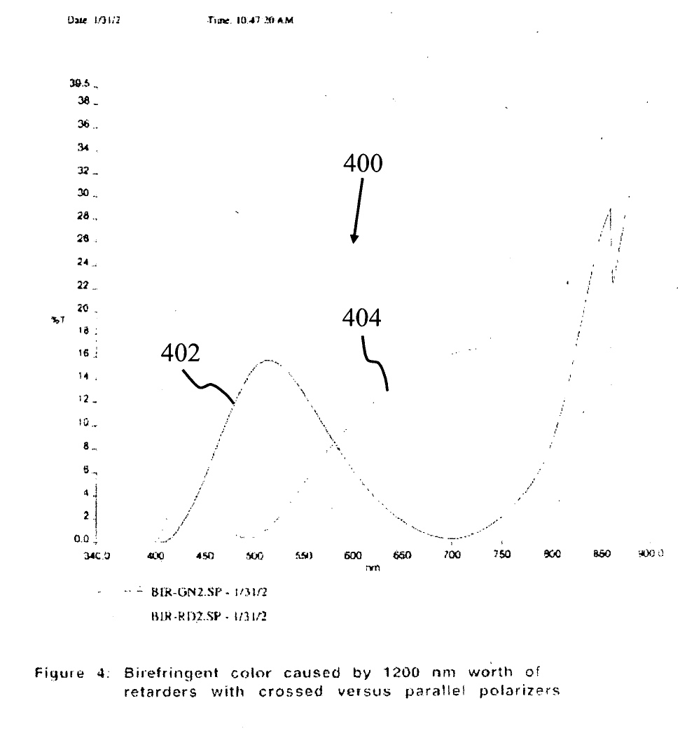

In FIG. 4, a graph 400 shows birefringent color caused by a 1200 nm total amount of retardation and comparing the performance of crossed versus parallel polarizers. Line 402 represents the frequency transmission of crossed polarizers with a set of 530 nm, 530 nm, and 140 nm retarders in place between the polarizers. The best transmission for the crossed polarizers in this example is at approximately 520 nm, in the blue/green range. The worst transmission for the crossed polarizers is at approximately 700 nm, in the red/orange range. The crossed polarizers with retarders in place therefore pass blue light and block red light (in the case of this exemplary red/blue embodiment). Other color combinations could be used in other embodiments.

Line 404 represents the frequency transmission of parallel polarizers with a set of 530 nm, 530 nm, and 140 nm retarders in place between the two polarizers. The best transmission for the parallel polarizers is approximately 730 nm, in the red/orange range. The worst transmission for the parallel polarizers is at approximately 490 nm, in the blue/green range. The parallel polarizers with retarders in place therefore pass red light and block blue light.

It should be noted, for example, that it is desirable that a local maxima of brightness for line 404 (at approximately 730 nm) substantially coincides with a local maxima of darkness (i.e., light blocking) for line 402 (at approximately 700 nm). High ratios of bright and dark transmission percentages between lines 402 and 404 are typically preferred for use. Also, a local maxima of brightness for line 402 (at approximately 520 nm) coincides with a local maxima of darkness (i.e. light blocking) of line 404 (at approximately 490 nm). The colors (i.e., frequencies) in FIG. 4 corresponding to these regions of substantially coinciding maximas are the colors that are desirably matched to the anaglyph image for use.

The above combination essentially provides approximately complementary colors, and it allows the fabrication of approximately complimentary colors using a pair of either linearly polarized glasses or circularly polarized glasses with the appropriate retarders. Assuming that these colors can be manufactured at the lens location on a pair of polarized glasses, the glasses can then be used to view an anaglyph image. The guest should then see a 3D image.

As the retardation value is changed, the relative positions and curves of the lines 402 and 404 typically will change. However, there should still be color combinations at substantially coinciding local maximas of brightness and darkness for which separation can be achieved. The colors at which separation occurs generally can be related to a standard Michel-Levy chart, which is typically only applicable to the use of crossed, and not parallel, polarizers. A chart providing similar information could also possibly be generated for the case of parallel polarizers. The use of a Michel-Levy chart is not required to practice the present disclosure.

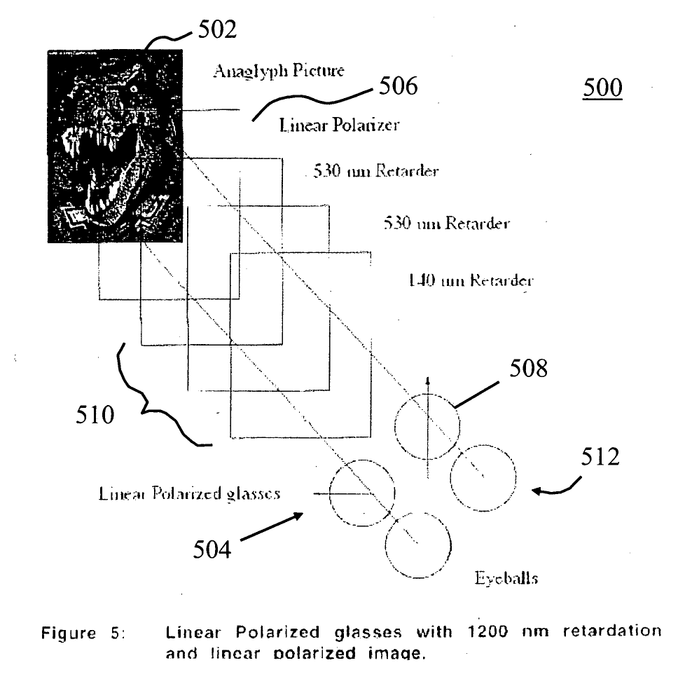

In FIG. 5, in a system 500, an anaglyph image 502 is linearly polarized and the guest is wearing linearly polarized glasses 504. In this particular embodiment, the polarizers in glasses 504 are, for example, at 90 degrees to each other and 45 degrees to the horizon. The linear polarizer 506 at the image 502 and the right eye polarizer 508 are in the crossed position with respect to each other (note that the system can be tuned either way such as with the crossed orientation being associated with the left eye). Once the image is polarized, the color is added to the system by inserting 1200 nm of total retardation 510. The right eye of the guest observer (note: eyeballs 512 are illustrated schematically as left and right eyeballs in FIG. 5) sees a blue/green retardation color (corresponding to crossed polarizers) while the left eye sees a red/orange retardation color (corresponding to parallel polarizers). The image is fused into a 3D image in the visual perception of the guest.

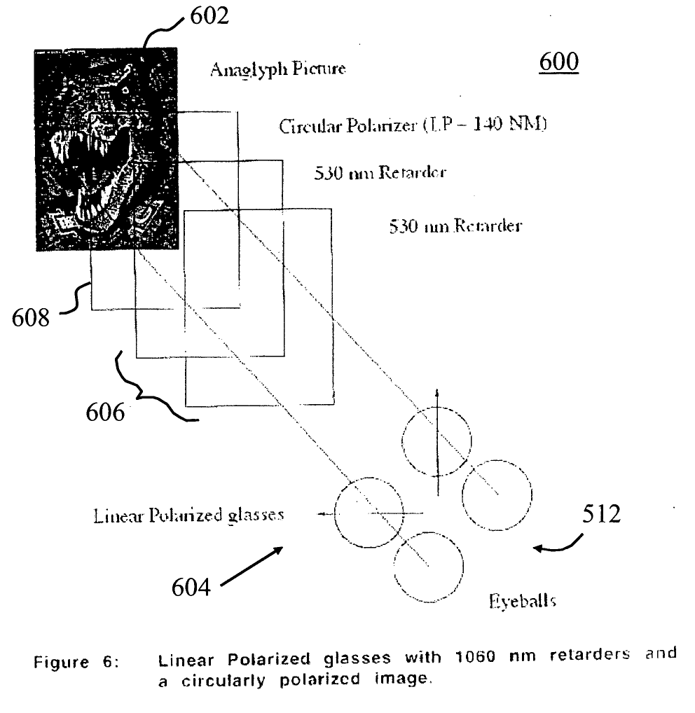

In FIG. 6, in a system 600, an anaglyph image 602 is circularly polarized and the guest is wearing linearly polarized glasses 604. Once the image 602 is polarized, the color is added to system 600 by inserting 1060 nm worth of retarders 606. The circular polarizer 608 has an embedded 140 nm retarder so that the entire retardation of system 600 is still 1200 nm. The right eye sees a blue/green retardation color while the left eye sees a red/orange retardation color. Image 602 is perceived as a 3D image by the observer.

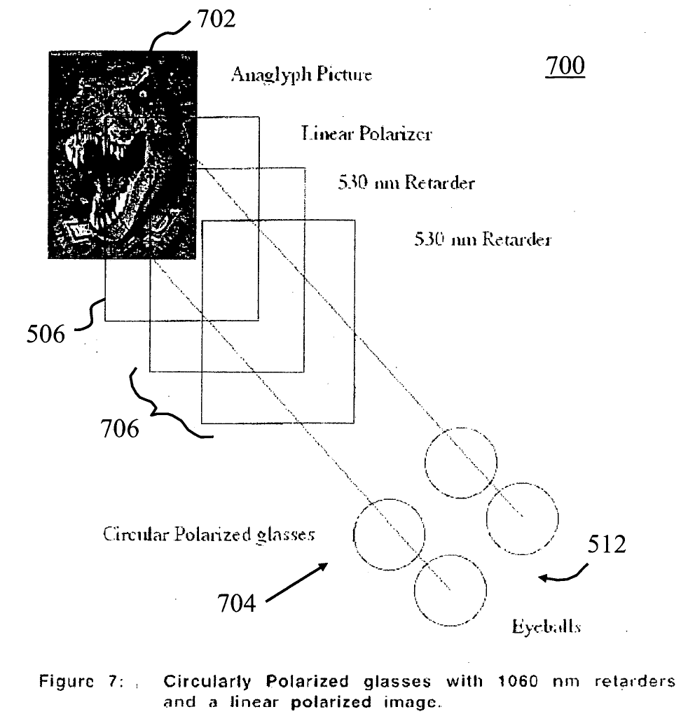

In FIG. 7, in a system 700, an anaglyph image 702 is linearly polarized and the guest is wearing circularly polarized glasses 704. Once the image 702 is polarized, the color is added to the system by inserting 1060 nm retardation using retarders 706 (each retarder provides 530 nm of retardation). The circular polarizers used in glasses 704 each have an embedded 140 nm retarder so that the entire retardation of the system 700 for each eye is still 1200 nm. The right eye sees a blue/green retardation color while the left eye sees a red/orange retardation color. The image 702 is perceived as a 3D image by the observer.

Now discussing some operational aspects of the disclosure, the system is light dependent. In general, crossed polarizers extinguish the light traveling through them, while parallel polarizers typically reduce the light by at least 50%. Dark images are not readily viewable with this technique. The system works well with an anaglyph image generated on a monitor. The image in this case is illuminated and can be readily seen even with the polarizers in place.

The system matches the color of the lens to the color of the ink or other coloring means used to make the image. It is desirable to determine the birefringent colors that may be useful and then to find inks or other coloring means that match those colors.

A workable system has been tested with transparencies and an illuminated light board (for example, a think slide table). However, it is desirable to avoid an unmatched ink/lens color, which may lead to a separation problem. Also, prior tests of the present system using hard scape systems have required back lit pieces. However, this may not be necessary in the use of other embodiments of the system.

The foregoing description of specific embodiments reveals the general nature of the disclosure sufficiently that others can, by applying current knowledge, readily modify and/or adapt it for various applications without departing from the generic concept. For example, in other variations, the amount of retardation used could be varied from that described above and also other light/color combinations could be selected as may be appropriate for a given application. Also, although the embodiments discussed above have discussed the use of glasses having a lens for each eye, in other embodiments each of the lenses could be other types of optical components, not necessarily mounted to a typical pair of eyeglasses, through which an observer is viewing an anaglyph image with each eye. In addition, in other embodiments the anaglyph image, the polarizer over the image, the retardation, and the polarized lenses could all be assembled or formed into a single pair of glasses so that the assembled glasses alone would contain all components necessary to view a 3D image, for example, when the glasses were being worn in natural daylight by the guest. Therefore, such adaptations and modifications are within the meaning and range of equivalents of the disclosed embodiments. The phraseology or terminology employed herein is for the purpose of description and not of limitation.

1. A method of viewing, by an observer, an image with polarized glasses, the method comprising:
introducing a polarizer in front of the image; and
introducing a retarder to transfer light rays from the image towards the observer wherein the light rays exhibit a phase difference upon exiting the retarder, whereby a first eye of the observer sees a first retardation color while a second eye of the observer sees a second retardation color.

2. The method of claim 1 wherein the first retardation color is blue/green and the second retardation color is red/orange.

3. The method of claim 1 wherein the polarizer introduced in front of the image is a linear or a circular polarizer.

4. The method of claim 1 wherein the first eye is a right eye and the second eye is a left eye.

5. The method of claim 1 wherein the observer's seeing of the first retardation color and the second retardation color is perceived as a three-dimensional image.

6. The method of claim 1 wherein the glasses are linearly or circularly polarized.

7. A method of viewing a three-dimensional image, the method comprising:
providing a polarizer between an anaglyph image and an observer;
providing a retarder to transmit light, coming from the anaglyph image, as first and second birefringent colors;
viewing by the observer of the first and second birefringent colors using polarized lenses; and
wherein the anaglyph image is created using first and second colors corresponding to the first and second birefringent colors.

8. The method of claim 7 wherein the color used to create the anaglyph image is the color of an ink used to form the anaglyph image.

9. The method of claim 7 wherein the viewing by the observer comprises viewing using glasses comprising the polarized lenses.

10. The method of claim 7 wherein the viewing by the observer comprises perceiving the anaglyph image as a three-dimensional image.

11. The method of claim 7 wherein the polarized lenses are capable of being used by an observer in alternately viewing a linearly polarized image and a circularly polarized image so that the observer perceives in each such viewing instance a three-dimensional image.

12. Glasses configured to view the anaglyph image of claim 7 using the method of claim 7.

13. The method of claim 7 wherein:
the polarized lenses comprise a first polarized lens and a second polarized lens;
the viewing by the observer comprises viewing the anaglyph image using the first polarized lens simultaneously with the viewing of the anaglyph image using the second polarized lens; and
the first polarized lens and the second polarized lens are each in a different polarization orientation with respect to the polarizer.

14. A method of viewing an image by an observer having a first eye and a second eye, the method comprising:
providing a polarizer between the image and the first and second eyes;
providing a retarder, positioned between the polarizer and the first and second eyes, to transmit light rays from the image to the observer; and
viewing the light rays from the retarder using a first polarized lens for viewing by the first eye and a second polarized lens for viewing by the second eye.

15. The method of claim 14 wherein:
the image is an anaglyph image; and
the polarizer over the image is a linear or circular polarizer.

16. The method of claim 15 wherein:
the polarizer over the image is a linear polarizer; and
the first polarized lens is linearly polarized.

17. The method of claim 15 wherein:
the polarizer over the image is a circular polarizer; and
the first polarized lens is linearly polarized.

18. The method of claim 14 wherein the retarder is a first retarder and further comprising providing a second retarder positioned to optically cooperate with the first retarder in transmitting the light rays from the image to the first and second polarized lenses.

19. The method of claim 18 wherein the second retarder is embedded in the polarizer.

20. The method of claim 14 wherein the polarizer is a circular or linear polarizer.

21. The method of claim 14 wherein the first polarized lens is circularly or linearly polarized.

22. The method of claim 14 wherein:
the image is an anaglyph image;
the polarizer is provided in contact with the image; and
the light rays transmitted by the retarder exhibit a phase difference upon exiting the retarder, whereby the first eye sees a first retardation color while the second eye sees a second retardation color.

23. The method of claim 22 wherein the first retardation color is blue/green and the second retardation color is red/orange.

24. The method of claim 22 wherein the first retardation color is an approximate complement of the second retardation color.

25. The method of claim 14 wherein:
the first polarized lens and the polarizer are in a crossed position with respect to each other; and
the second polarized lens and the polarizer are in a parallel position with respect to each other.

26. A system for viewing an image by an observer having a first eye and a second eye, the system comprising:
a first polarizer positioned to transmit light rays from the image;
a second polarizer positioned to transmit light rays from the first polarizer to the first eye;
a third polarizer positioned to transmit light rays from the first polarizer to the second eye; and
a retardation positioned so that light transmitted from the first polarizer passes through the retardation to the first and second eyes.

27. The system of claim 26 wherein the retardation comprises a birefringent material.

28. The system of claim 26 wherein the retardation comprises one or more retarders that optically cooperate to transmit the light from the first polarizer to the first and second eyes.

29. The system of claim 26 wherein:
the first polarizer and the second polarizer are in a crossed position with respect to each other; and
the first polarizer and the third polarizer are in a parallel position with respect to each other.

30. The system of claim 29 wherein the second polarizer and the third polarizer are disposed in glasses for wearing by the observer.

31. The system of claim 29 wherein:
the retardation transmits light of a first retardation color and a second retardation color; and
the first retardation color is approximately complementary to the second retardation color.

32. The system of claim 31 wherein the first retardation color and the second retardation color are matched to colors used to form the image.

33. The system of claim 26 wherein the retardation comprises a set of one or more retarders to provide a total retardation of about 1200 nm.
